(19) United States
(12) Patent Application Publication
(10) Pub. No.: US 2025/0279588 A1
(43) Pub. Date: Sep. 4, 2025

(54) ANTENNA AND COMMUNICATION DEVICE

(71) Applicant: Huawei Technologies Co., Ltd., Shenzhen (CN)

(72) Inventors: Lijun Pan, Dongguan (CN); Jianrong Li, Shenzhen (CN); Jianfeng Wei, Shanghai (CN); Wenhui Deng, Dongguan (CN); Jian Gong, Shenzhen (CN)

(21) Appl. No.: 19/206,814

(22) Filed: May 13, 2025

Related U.S. Application Data
(63) Continuation of application No. PCT/CN2023/124660, filed on Oct. 16, 2023.

(30) Foreign Application Priority Data
Nov. 14, 2022 (CN) 202211424422.2

(51) Int. Cl. H01Q 15/14; H01Q 1/42; H01Q 3/12; H01Q 9/28

(52) U.S. Cl. CPC H01Q 15/14; H01Q 1/42; H01Q 3/12; H01Q 9/28

(57) ABSTRACT

An antenna and a communications device having an antenna, the antenna including a radome and a first stepped reflection panel disposed in the radome. The first stepped reflection panel has n first mounting plates and each first mounting plate of the n first mounting plates has a first surface and a second surface that faces away from the first surface, and further has a first radiating element disposed on the first surface. An (i−1)^{th} first mounting plate of the n first mounting plates is disposed adjacent to a second surface of an i^{th} first mounting plate of the n first mounting plates, and the (i−1)^{th} first mounting plate is connected to the i^{th} first mounting plate by a first connecting piece.

### CROSS-REFERENCE TO RELATED APPLICATIONS

This application is a continuation of International Application No. PCT/CN2023/124660, filed on Oct. 16, 2023, which claims priority to Chinese Patent Application No. 202211424422.2, filed on Nov. 14, 2022. The disclosures of the aforementioned applications are hereby incorporated by reference in their entireties.

### TECHNICAL FIELD

This application relates to the field of communication technologies, and in particular, to an antenna and a communication device.

### BACKGROUND

Antennas are widely used in a plurality of different types of communication devices, and are configured to send or receive a radio signal. For example, an antenna may be mounted on a signal tower or a signal pole of a base station, to improve a signal sending/receiving capability, a signal coverage area, and the like of the antenna. Specifically, the antenna in the base station includes a radome. Based on different application scenarios, the radome may be set to be in different shapes, for example, a rectangular radome, a conical radome, or a circular radome. A reflection panel, an array antenna, a feeding network module, and the like are disposed in the radome. However, because internal space of the radome is limited, even if array antennas are disposed in a direction of a maximum size of the radome, a spacing between adjacent array antennas is small. Consequently, coupling occurs between the array antennas, and performance of the antenna is affected.

### SUMMARY

This application provides an antenna and a communication device, so that adjacent array antennas are spaced by a specified distance, to reduce coupling between the array antennas, and improve directivity pattern performance of the antenna.

According to a first aspect, this application provides an antenna. The antenna may specifically include a radome and a first stepped reflection panel, and the first stepped reflection panel is disposed in the radome. Specifically, the first stepped reflection panel may include n first mounting plates, and n is an integer and n>1. Each first mounting plate has a first surface and a second surface, and the first surface faces away from the second surface. A first radiating element is disposed on the first surface of the first mounting plate. In the n first mounting plates, an (i−1)^{th} first mounting plate is disposed close to a second surface of an i^{th} first mounting plate, and is connected to the i^{th} first mounting plate through a first connecting piece, and i is an integer and 1<i≤n.

In the antenna of the foregoing structure, the first radiating element is mounted on the first mounting plate of the first stepped reflection panel, to form an array antenna. Based on a 1^{st} first mounting plate, heights of a 2^{nd} first mounting plate to an nth first mounting plate gradually increase in a step extension direction, so that array antennas disposed on two adjacent first mounting plates have a first spacing in a first direction parallel to the first mounting plate and a second spacing in a second direction perpendicular to the first mounting plate. Therefore, in the antenna in this application, the array antennas disposed on the two adjacent first mounting plates are spaced by a specific spacing in each of the first direction and the second direction, to reduce coupling between the array antennas, and improve directivity pattern performance of the antenna. In addition, when the second spacing between the array antennas disposed on the two adjacent first mounting plates is ensured, the first spacing may be reduced based on a requirement of an application scenario, thereby facilitating miniaturization of the antenna.

In this application, the antenna may be a single-sided antenna or a double-sided antenna. For example, in some technical solutions, the antenna is a double-sided antenna. The antenna further includes a second stepped reflection panel, and the second stepped reflection panel is disposed in the radome. The second stepped reflection panel includes m second mounting plates, and m is an integer and m>1. Each second mounting plate has a third surface and a fourth surface that faces away from the third surface. A second radiating element is disposed on the third surface. A (j−1)^{th} second mounting plate is disposed close to a fourth surface of a j^{th} second mounting plate, the (j−1)^{th} second mounting plate is connected to an m^{th} second mounting plate through a second connecting piece, and j is an integer and 1<j≤m. During specific disposition, the second stepped reflection panel is disposed on a side that is of the first stepped reflection panel and that faces away from the first radiating element. The first stepped reflection panel is disposed on a side that is of the second stepped reflection panel and that faces away from the second radiating element. Therefore, radiation directions of the first radiating element and the second radiating element are different, so that the antenna can have two radiation directions.

When the first stepped reflection panel is specifically disposed, the n first mounting plates may be disposed in parallel. This facilitates setting of a spacing between first radiating elements on two adjacent first mounting plates, thereby simplifying a structure of the antenna. In some other technical solutions, at least one of the n first mounting plates may be disposed at an included angle with an adjacent first mounting plate. For example, a q^{th} first mounting plate is disposed at an included angle with a (q−1)^{th} first mounting plate, and q is an integer and 1<q≤n. In this way, the first stepped reflection panel can be adapted to a radome having an irregular shape inside, and a directivity pattern of the antenna can be symmetrical, thereby improving directivity pattern performance of the antenna.

When the second stepped reflection panel is specifically disposed, the m second mounting plates may be disposed in parallel. This facilitates setting of a spacing between second radiating elements on two adjacent second mounting plates, thereby simplifying a structure of the antenna. In some other technical solutions, at least one of the m second mounting plates may be disposed at an included angle with an adjacent second mounting plate. For example, a p^{th} second mounting plate is disposed at an included angle with a (p−1)^{th} second mounting plate, and p is an integer and 1<p≤m. In this way, the second stepped reflection panel can be adapted to a radome having an irregular shape inside, and a directivity pattern of the antenna can be symmetrical, thereby improving directivity pattern performance of the antenna.

In a possible technical solution, when the n first mounting plates of the first stepped reflection panel are disposed in parallel, and the m second mounting plates of the second stepped reflection panel are disposed in parallel, the first mounting plate of the first stepped reflection panel and the second mounting plate of the second stepped reflection panel may be disposed in parallel. In this way, the antenna has two opposite radiation directions. Certainly, the first mounting plate may alternatively be disposed at an included angle with the second mounting plate. In other words, two radiation directions may be randomly selected as radiation directions of the double-sided antenna based on different application scenarios.

In this application, a shape of the radome is not specifically limited. For example, the radome may be a cylindrical radome, a conical radome, a spherical radome, or another radome in an irregular shape. When the radome is a cylindrical radome, a cross section that is of the radome and that is perpendicular to an axial direction may be a triangle, a rectangle, or another polygon, or the cross section may be a circle, an ellipse, or an irregular shape with an arc.

When the first radiating element is specifically disposed, the first radiating element may include a first-type radiating element and a second-type radiating element, and a radiation frequency of the first-type radiating element is different from a radiation frequency of the second-type radiating element. To be specific, only a first-type radiating element may be disposed, only a second-type radiating element may be disposed, or a first-type radiating element and a second-type radiating element may be disposed on a single first mounting plate. Therefore, the first radiating element on the first mounting plate may have one or two radiation frequencies, thereby implementing a single-frequency, dual-frequency, or multi-frequency working state.

In addition, the first-type radiating element is disposed on a first surface of the (i−1)^{th} first mounting plate, and the second-type radiating element is disposed on a first surface of the i^{th} first mounting plate. When radiation frequencies of first radiating elements on a single first mounting plate are the same, radiation frequencies of first radiating elements on two adjacent first mounting plates may be different. This can also implement a dual-frequency or multi-frequency working state.

When a structure of the first stepped reflection panel is specifically disposed, a specific type of the first connecting piece is not limited. For example, in a possible technical solution, the first connecting piece may be a connecting plate. The connecting plate is connected between two adjacent first mounting plates, and the connecting plate is disposed at an included angle with the first mounting plate. The included angle may be, for example, 5°, 10°, 35°, 61°, 80°, 89°, or 90°. This is not specifically limited herein. Alternatively, in another possible technical solution, the first connecting piece may be a connecting bracket, and the n first mounting plates are separately fastened to the connecting bracket.

A connection manner of the connecting plate and the first mounting plate is not limited, for example, may be threaded connection, welding, riveting, bonding, or the like. This is not specifically limited herein. Certainly, the first mounting plate and the connecting plate may alternatively form an integrated structure by using an integral formation process.

In addition, the n first mounting plates may be evenly spaced in a direction perpendicular to the first mounting plate. For example, in some technical solutions, the antenna may be a single-frequency antenna. In this case, that the first mounting plates are evenly spaced facilitates batch production of the antenna. Certainly, based on different radiation frequency requirements or size requirements of the antenna, these first mounting plates may alternatively not be evenly spaced. This is not specifically limited herein.

Similarly, the m second mounting plates may be evenly spaced in a direction perpendicular to the second mounting plate. For example, in some technical solutions, the antenna may be a single-frequency double-sided antenna. In this case, that the n first mounting plates and the m second mounting plates are separately evenly spaced facilitates batch production of the antenna. Certainly, based on different radiation frequency requirements or size requirements of the antenna, these second mounting plates may alternatively not be evenly spaced. This is not specifically limited herein.

In the technical solution of this application, the antenna may further include a rotation drive apparatus. The rotation drive apparatus is connected to the first stepped reflection panel and/or the second stepped reflection panel, and the rotation drive apparatus is configured to drive the first stepped reflection panel and/or the second stepped reflection panel to rotate. The antenna may be used in a communication device. After the antenna is mounted on a mounting bracket of the communication device, the rotation drive apparatus may be controlled to drive the first stepped reflection panel and/or the second stepped reflection panel to rotate at any angle, to change a radiation direction.

According to a second aspect, this application provides a communication device. The communication device includes a mounting bracket and the antenna in the first aspect. The antenna is disposed on the mounting bracket. In the communication device, first radiating elements on the first mounting plates are distributed in a stepped manner. Therefore, after first radiating elements on each first mounting plate form an array antenna, array antennas disposed on two adjacent first mounting plates respectively have specific spacings in the first direction and the second direction, to reduce coupling between the array antennas, and improve directivity pattern performance of the antenna. In addition, when a spacing in the second direction between the array antennas disposed on the two adjacent first mounting plates is ensured, a spacing in the first direction may be reduced based on a requirement of an application scenario, thereby facilitating miniaturization of the antenna.

### BRIEF DESCRIPTION OF THE DRAWINGS

FIG. 1 is a diagram of an application scenario of a communication device according to an embodiment of this application;

FIG. 2 is a diagram of a structure of a communication device according to an embodiment of this application;

FIG. 3 is a block diagram of a structure of an antenna according to an embodiment of this application;

FIG. 4 is a diagram of a structure of an antenna according to an embodiment of this application;

FIG. 5 is a diagram of a structure of a first stepped reflection panel and a first radiating element according to an embodiment of this application;

FIG. 6 is a diagram of another structure of a first stepped reflection panel and a first radiating element according to an embodiment of this application;

FIG. 7 is a diagram of another structure of a first stepped reflection panel and a first radiating element according to an embodiment of this application;

FIG. 8 is a diagram of another structure of a first stepped reflection panel and a first radiating element according to an embodiment of this application;

FIG. 9 is a diagram of another structure of a first stepped reflection panel and a first radiating element according to an embodiment of this application;

FIG. 10 is a diagram of another structure of a first stepped reflection panel and a first radiating element according to an embodiment of this application;

FIG. 11 is a diagram of another structure of an antenna according to an embodiment of this application;

FIG. 12 is a diagram of another structure of an antenna according to an embodiment of this application; and

FIG. 13 is a diagram of another structure of an antenna according to an embodiment of this application.

### REFERENCE NUMERALS

10—base station;
20—terminal;
11—antenna;
12—feeder;
13—grounding device;
14—mounting bracket;
15—mounting piece;
16—radio frequency processing unit;
17—baseband processing unit;
111—radome;
112—first stepped reflection panel;
113—feeding network;
114—first mounting plate;
115—first radiating element;
115a—first-type radiating element;
115b—second-type radiating element;
116—first connecting piece;
122—second stepped reflection panel;
123—second mounting plate;
124—second radiating element; and
125—second connecting piece.

### DETAILED DESCRIPTION OF ILLUSTRATIVE EMBODIMENTS

To make objectives, technical solutions, and advantages of this application clearer, the following further describes this application in detail with reference to the accompanying drawings.

In a current base station antenna, in addition to a conventional cube, a shape of a radome further includes a cylinder, a cone, a sphere, or another irregular shape. Limited by the shape of the radome, internal space of the radome is also limited. Therefore, array antennas usually need to be disposed in a direction of a maximum size of the radome. However, to reduce a coupling phenomenon between two adjacent array antennas, the two adjacent array antennas need to be spaced by a specific distance. As a result, the array antennas have a relatively large overall size, and have a relatively simple arrangement in the radome. This does not facilitate miniaturization of the antenna.

Therefore, this application provides an antenna and a communication device, so that adjacent array antennas are spaced by a specified distance, to reduce coupling between the array antennas, and improve directivity pattern performance of the antenna.

Reference to “an embodiment”, “some embodiments”, or the like described in this specification indicates that one or more embodiments of this application include a specific feature, structure, or characteristic described with reference to the embodiment. Therefore, statements such as “in an embodiment”, “in another embodiment”, “in some embodiments”, “in some other embodiments”, and “in other embodiments” that appear at different places in this specification do not necessarily mean reference to a same embodiment. Instead, the statements mean “one or more but not all of embodiments”, unless otherwise specifically emphasized in another manner. The terms “include”, “cover”, “have”, and their variants all mean “including but not limited to”, unless otherwise specifically emphasized in another manner. In addition, terms such as “first”, “second”, “third”, “fourth”, “fifth”, “sixth”, “1^{st}”, “2^{nd}”, “3^{rd}”, and “4^{th}” described in this specification are merely used for more concise descriptions and to help a reader locate positions of described objects in figures, but do not constitute specific limitations on quantities of indicated objects.

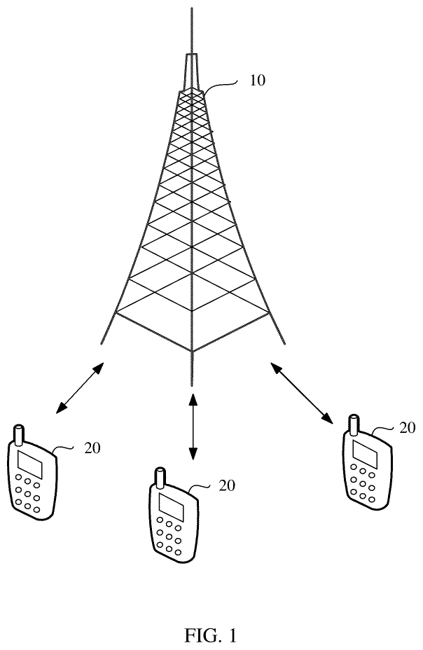

The communication device provided in embodiments of this application may be a communication device such as a base station or radar, to implement a wireless communication function. FIG. 1 is a diagram of an application scenario of a communication device according to an embodiment of this application. As shown in FIG. 1, the application scenario may include a base station 10 and a terminal 20. Wireless communication may be implemented between the base station 10 and the terminal 20. The base station 10 may be located in a universal mobile telecommunications system (UTMS) terrestrial radio access network (UTRAN), a base station subsystem (BBS), or an evolved universal terrestrial radio access (E-UTRAN), and is configured to perform area coverage of a radio signal, to implement communication between a terminal device and a wireless network. Specifically, the base station 10 may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB or eNodeB) in a long term evolution (LTE) system, or may be a radio controller in a cloud radio access network (CRAN) scenario. Alternatively, the base station 10 may be a relay station, an access point, a vehicle-mounted device, a wearable device, a g node (gNodeB or gNB) in a new radio (NR) system, a base station in a future evolved network, or the like. This is not specifically limited in this embodiment of this application.

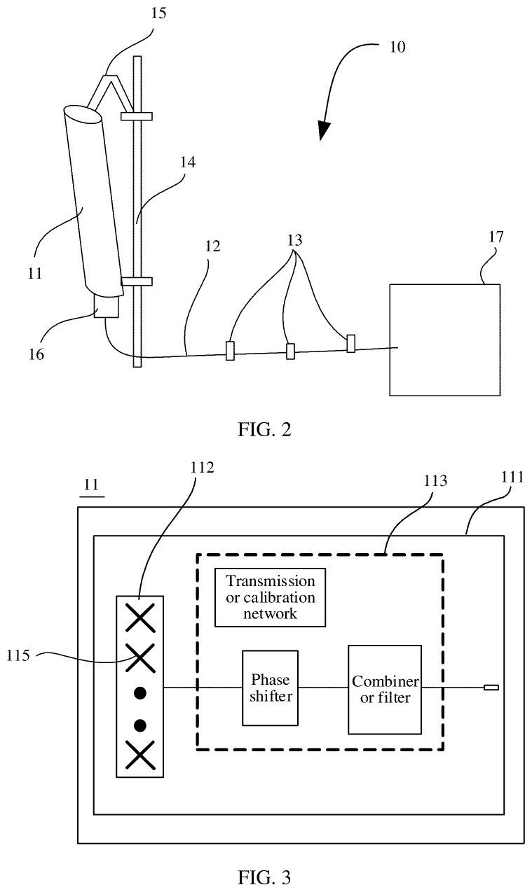

FIG. 2 is a diagram of a structure of a communication device according to an embodiment of this application. As shown in FIG. 2, the communication device may be a base station 10, and specifically includes a base station antenna feeder system. During actual application, the base station antenna feeder system mainly includes an antenna 11, a feeder 12, a grounding device 13, and the like. The antenna 11 is usually fastened to a mounting bracket 14, and a tilt angle of the antenna 11 may be adjusted by adjusting a mounting piece 15, to adjust a signal coverage area of the antenna 11 to a specific extent.

In addition, the base station 10 may further include a radio frequency processing unit 16 and a baseband processing unit 17. For example, the radio frequency processing unit 16 may be configured to: perform frequency selection, amplification, and down-conversion processing on a signal received by the antenna 11, convert the signal into an intermediate frequency signal or a baseband signal, and send the intermediate frequency signal or the baseband signal to the baseband processing unit 17. Alternatively, the radio frequency processing unit 16 is configured to: perform up-conversion and amplification processing on an intermediate frequency signal sent by the baseband processing unit 17, convert the signal into a radio signal through the antenna 11, and send the radio signal. The baseband processing unit 17 may be connected to a feeding network of the antenna 11 through the radio frequency processing unit 16. In some implementations, the radio frequency processing unit 16 may also be referred to as a remote radio unit (RRU), and the baseband processing unit 17 may also be referred to as a baseband unit (BBU).

As shown in FIG. 2, in some embodiments, the radio frequency processing unit 16 and the antenna 11 may be integrated, the baseband processing unit 17 is located at a remote end of the antenna 11, and the radio frequency processing unit 16 may be connected to the baseband processing unit 17 through the feeder 12. In some other embodiments, both the radio frequency processing unit 16 and the baseband processing unit 17 may be located at a remote end of the antenna 11.

FIG. 3 is a block diagram of a structure of an antenna according to an embodiment of this application. As shown in FIG. 3, the antenna 11 used in the base station 10 may further include a radome 111, and a first stepped reflection panel 112, a first radiating element 115, and a feeding network 113 that are located in the radome 111. The first stepped reflection panel 112 may also be referred to as a stepped bottom plate. A main function of the feeding network 113 is to feed, based on a specific amplitude and phase, a signal to an array antenna including first radiating elements 115, or send a radio signal received by the array antenna to the baseband processing unit 17 of the base station 10 based on a specific amplitude and phase. It may be understood that, during specific implementation, the feeding network 113 may include at least one of a phase shifter, a combiner, a transmission or calibration network, a filter, or the like. A component and a type of the feeding network 113 and a function that can be implemented by the feeding network 113 are not limited in this application.

Certainly, the antenna 11 may be further used in a plurality of other types of communication devices. An application scenario of the antenna 11 is not limited in this application.

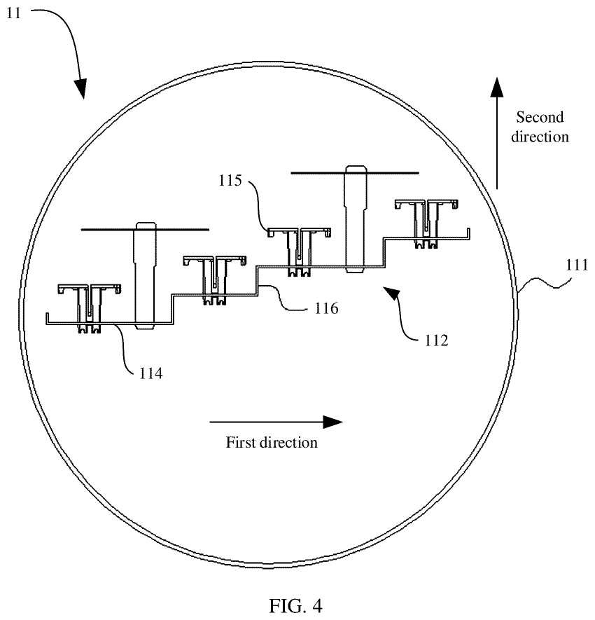

FIG. 4 is a diagram of a structure of an antenna according to an embodiment of this application. As shown in FIG. 4, in this application, a shape of the radome 111 is not specifically limited. In some embodiments, the radome 111 may be a cylindrical radome, a conical radome, or a spherical radome. For example, when the radome 111 is a cylindrical radome, a cross section that is of the radome 111 and that is perpendicular to an axial direction may be a polygon, a circle, or an ellipse, or the cross section may be an irregular shape with an arc. For example, the radome 111 may be cylindrical, and a wall of the radome 111 may be wavy. Certainly, based on different requirements, a surface of the radome 111 may be processed to form different patterns. In terms of electrical performance, the radome 111 has a good electromagnetic wave penetration property, so that normal sending/receiving of an electromagnetic signal between the array antenna and the outside is not affected. In terms of mechanical performance, the radome 111 has a good force-bearing property, oxidation resistance property, and the like, and therefore can withstand corrosion in an outside harsh environment.

The first stepped reflection panel 112 is disposed in the radome 111, and the first stepped reflection panel 112 has a first surface (for example, an upper surface in FIG. 4) and a second surface (for example, a lower surface in FIG. 4). Specifically, the first stepped reflection panel 112 may include n first mounting plates 114, and n=2, 3, 4, 5, . . . . At least one first radiating element 115 is disposed on a first surface of each first mounting plate 114. Usually, the first radiating element 115 is mounted on one side of the first surface of the first stepped reflection panel 112, and the feeding network 113 is mounted on one side of the second surface. Feeding is performed between the feeding network 113 and the first radiating element 115 through a cable (for example, a coaxial cable), so that the feeding network 113 feeds a signal to the first radiating element 115 based on a specific amplitude and phase. The first radiating element 115 may also be referred to as an antenna element, and can effectively transmit or receive an electromagnetic wave. During specific application, antenna elements may be classified into a single-polarization type, a dual-polarization type, and the like. During specific configuration, a type of the antenna element may be properly selected based on an actual requirement.

In some embodiments, one first radiating element 115 may be disposed on each first mounting plate 114. Alternatively, in some other embodiments, two or more first radiating elements 115 may be disposed on each first mounting plate 114, and a plurality of first radiating elements 115 disposed on each first mounting plate 114 may form an array antenna. Alternatively, in some other embodiments, one first radiating element 115 is disposed on an (i−1)^{th} first mounting plate 114, two or more first radiating elements 115 are disposed on an i^{th} first mounting plate 114, and i=2, 3, . . . , n. In this embodiment of this application, a shape of the first stepped reflection panel 112 may meet the following: In the i first mounting plates 114, the (i−1)^{th} first mounting plate 114 is connected to the i^{th} first mounting plate 114 through a first connecting piece 116, and is disposed on one side of a second surface of the i^{th} first mounting plate 114.

The antenna 11 shown in FIG. 4 is used as an example. The first stepped reflection panel 112 of the antenna 11 includes four first mounting plates 114 disposed in parallel. A 1^{st} first mounting plate 114 on a left side is used as a 1^{st} first mounting plate 114 of the first stepped reflection panel 112, and heights of 2^{nd}, 3^{rd}, and 4^{th} first mounting plates 114 relative to the 1^{st} first mounting plate 114 gradually increase in a first direction (a step extension direction) parallel to the first mounting plate 114. In other words, the n first mounting plates 114 of the first stepped reflection panel 112 are distributed in an ascending or descending step shape. In this way, first radiating elements 115 on two adjacent first mounting plates 114 have a first spacing in the first direction, and have a second spacing in a second direction perpendicular to the first mounting plate 114. In the antenna 11 of this application, a plurality of first radiating elements 115 on each first mounting plate 114 may form an array antenna, and array antennas disposed on two adjacent first mounting plates 114 are spaced by a specific spacing in each of the first direction and the second direction, so that a center distance between the array antennas disposed on the two adjacent mounting plates can be increased, to reduce coupling between the array antennas, improve radiation indicators and isolation of the adjacent array antennas, and improve directivity pattern performance of the antenna 11. In addition, when the second spacing between the two adjacent array antennas is ensured, the first spacing may be reduced based on a requirement of an application scenario, in other words, a size of the first stepped reflection panel 112 in the first direction may be reduced, so that an overall size of the antenna 11 can be reduced, thereby facilitating miniaturization of the antenna 11.

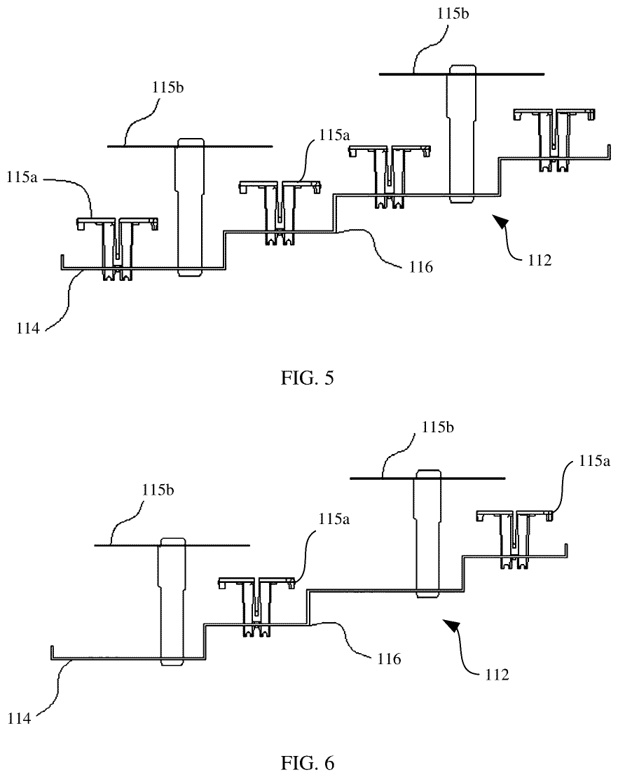

FIG. 5 is a diagram of a structure of a first stepped reflection panel and a first radiating element according to an embodiment of this application. When the first radiating element 115 is specifically disposed, the first radiating element 115 may include a first-type radiating element 115a and a second-type radiating element 115b, and a radiation frequency of the first-type radiating element 115a may be different from a radiation frequency of the second-type radiating element 115b. As shown in FIG. 5, starting from a left side, a first-type radiating element 115a and a second-type radiating element 115b are disposed on each of a 1^{st} first mounting plate 114 and a 3^{rd} first mounting plate 114. In other words, a first radiating element 115 on each of the 1^{st} first mounting plate 114 and the 3^{rd} first mounting plate 114 may have at least two radiation frequencies, thereby implementing a dual-frequency or multi-frequency working state. In this embodiment, a plurality of first-type radiating elements 115a and a plurality of second-type radiating elements 115b may be disposed on one first mounting plate 114. The plurality of first-type radiating elements 115a may be arranged in a first array, to form a first array antenna. The plurality of second-type radiating elements 115b may be arranged in a second array, to form a second array antenna. On the first mounting plate 114, the first array antenna and the second array antenna may be spaced by a specific distance. For example, as shown in FIG. 5, the first array antenna includes a column of first-type radiating elements 115a, the second array antenna includes a column of second-type radiating elements 115b, and the first-type radiating element column and the second-type radiating element column are spaced by a specific distance on the first mounting plate 114. Certainly, the first array antenna and the second array antenna may alternatively be alternately disposed with each other. For example, in some embodiments, the first array antenna includes a plurality of columns of first-type radiating elements 115a, the second array antenna includes a plurality of columns of second-type radiating elements 115b, and the first-type radiating element columns and the second-type radiating element columns are alternately disposed in the first direction. Alternatively, in some other embodiments, the first array antenna includes a plurality of first-type radiating element rings with different diameters, and each first-type radiating element ring may include a plurality of first-type radiating elements 115a; and the second array antenna includes a plurality of second-type radiating element rings with different diameters, and each second-type radiating element ring may include a plurality of second-type radiating elements 115b. On the first mounting plate 114, the first-type radiating element rings and the second-type radiating element rings are alternately disposed.

FIG. 6 is a diagram of another structure of a first stepped reflection panel and a first radiating element according to an embodiment of this application. As shown in FIG. 6, in some embodiments, the first-type radiating element 115a is disposed on a first surface of the i^{th} first mounting plate 114, and the second-type radiating element 115b is disposed on a first surface of the (i−1)^{th} first mounting plate 114. When radiation frequencies of first radiating elements 115 on a single first mounting plate 114 are the same, radiation frequencies of first radiating elements 115 on two adjacent first mounting plates 114 may be different. This can also implement a dual-frequency or multi-frequency working state.

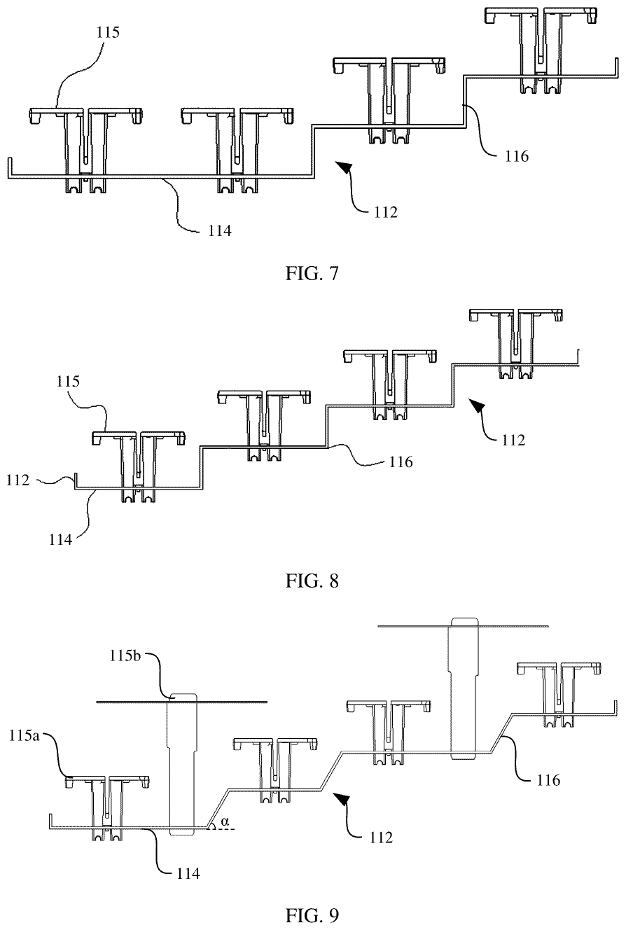

Certainly, a radiation frequency of the first-type radiating element 115a may alternatively be the same as a radiation frequency of the second-type radiating element 115b. In other words, the first radiating element 115 on the first mounting plate 114 has one radiation frequency. As shown in FIG. 5, starting from the left side, first radiating elements 115 having a same radiation frequency are disposed on each of a 2^{nd} first mounting plate 114 and a 4^{th} first mounting plate 114. In another single-frequency array antenna, first radiating elements 115 may be alternatively disposed in another arrangement manner. FIG. 7 is a diagram of another structure of a first stepped reflection panel and a first radiating element according to an embodiment of this application. As shown in FIG. 7, in some embodiments, starting from a left side, two columns of first radiating elements 115 are disposed on a 1^{st} first mounting plate 114, one column of first radiating elements 115 is disposed on each of a 2^{nd} first mounting plate 114 and a 3^{rd} first mounting plate 114, and radiation frequencies of the first radiating elements 115 on the 1^{st} first mounting plate 114, the 2^{nd} first mounting plate 114, and the 3^{rd} first mounting plate 114 are the same. FIG. 8 is a diagram of another structure of a first stepped reflection panel and a first radiating element 115 according to an embodiment of this application. As shown in FIG. 8, in some other embodiments, one column of first radiating elements 115 may be disposed on each first mounting plate 114, and radiation frequencies of first radiating elements 115 on all first mounting plates 114 are the same.

FIG. 9 is a diagram of another structure of a first stepped reflection panel and a first radiating element according to an embodiment of this application. As shown in FIG. 9, when a structure of the first stepped reflection panel 112 is specifically disposed, the first connecting piece 116 may be a connecting plate. The connecting plate is connected between two adjacent first mounting plates 114, and the connecting plate is disposed at an included angle with the first mounting plate 114. The included angle α may be, for example, 5°, 10°, 35°, 61°, 80°, 89°, or 90°. A specific value of the included angle α may be set based on the first spacing and the second spacing in the foregoing descriptions related to FIG. 4. This is not specifically limited herein. In this embodiment of this application, a connection manner of the connecting plate and the first mounting plate 114 is not limited, for example, may be threaded connection, welding, riveting, bonding, or the like. This is not specifically limited herein. Certainly, the first mounting plate 114 and the connecting plate may alternatively form an integrated structure by using an integral formation process, thereby improving structural strength of the first stepped reflection panel 112. In some other embodiments, the n first mounting plates 114 of the first stepped reflection panel 112 may alternatively be indirectly connected. For example, in a specific embodiment, the first connecting piece 116 may be a bolt, and the first mounting plate 114 of the first stepped reflection panel 112 may be fastened to an inner wall of the radome 111 through the bolt, so that the n first mounting plates 114 are indirectly connected through the radome 111, thereby simplifying a structure of the antenna 11. Certainly, in some other embodiments, the first connecting piece 116 may alternatively be a comb-shaped bracket. The comb-shaped bracket has a plurality of connecting parts disposed corresponding to the n first mounting plates 114. In this way, the n first mounting plates 114 are respectively connected to the corresponding connecting parts, to form the first stepped reflection panel 112.

In addition, the n first mounting plates 114 may be evenly spaced in a direction perpendicular to the first mounting plate 114. For example, in some technical solutions, the antenna 11 may be a single-frequency antenna. In this case, that the first mounting plates 114 are evenly spaced facilitates batch production of the antenna 11. Certainly, based on different radiation frequency requirements or size requirements of the antenna 11, these first mounting plates 114 may alternatively not be evenly spaced.

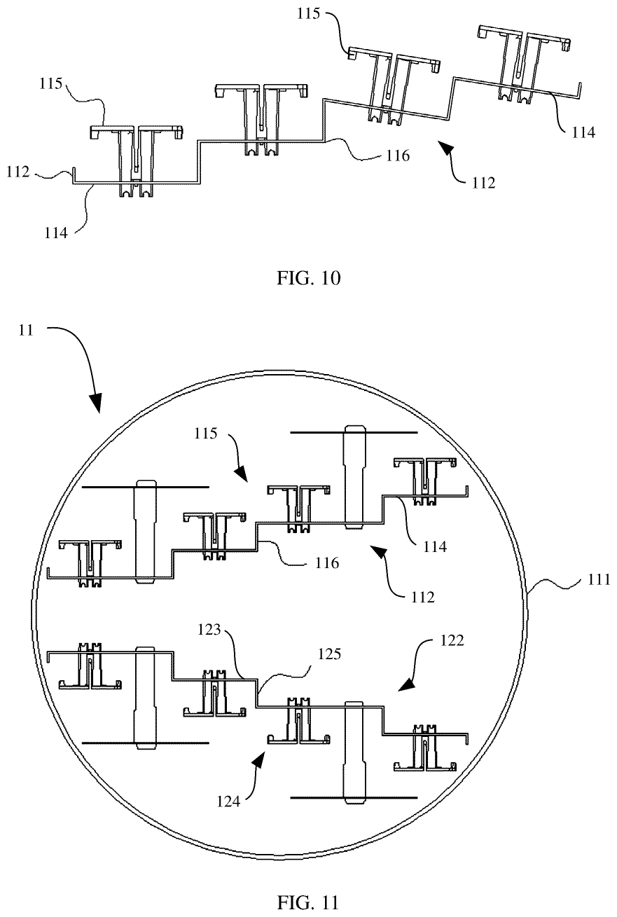

In this application, the n first mounting plates 114 may be disposed in parallel. This facilitates setting of a spacing between first radiating elements 115 on two adjacent first mounting plates 114, thereby simplifying a structure of the antenna 11. Alternatively, at least one of the n first mounting plates 114 may be disposed at an included angle with an adjacent first mounting plate 114. For example, a q^{th} first mounting plate 114 is disposed at an included angle with a (q−1)^{th} first mounting plate 114, and q is an integer and 1<q≤n. In this way, the first stepped reflection panel 112 can be adapted to a radome 111 having an irregular shape inside, and a directivity pattern of the antenna 11 can be symmetrical, thereby improving directivity pattern performance of the antenna 11. FIG. 10 is a diagram of another structure of a first stepped reflection panel and a first radiating element according to an embodiment of this application. As shown in FIG. 10, the first stepped reflection panel 112 may include four first mounting plates 114. A 1^{st} first mounting plate 114 and a 2^{nd} first mounting plate 114 are disposed in parallel, a 3^{rd} first mounting plate 114 and a 4^{th} first mounting plate 114 are disposed in parallel, and the 3^{rd} first mounting plate 114 is disposed at an included angle with the 2^{nd} first mounting plate 114. In this embodiment of this application, when a size of the radome 111 is relatively small and the inner wall is in an irregular shape, two adjacent first mounting plates 114 are disposed at an included angle, thereby ensuring that centers of array antennas disposed on the two mounting plates are spaced by a specific distance. In addition, because the first connecting piece 116 affects beam symmetry of the first radiating element 115, two adjacent first mounting plates 114 are disposed at an included angle, so that a directivity pattern of the antenna 11 can be more symmetrical, thereby further improving directivity pattern performance of the antenna 11. Specifically, the included angle may be less than 180°.

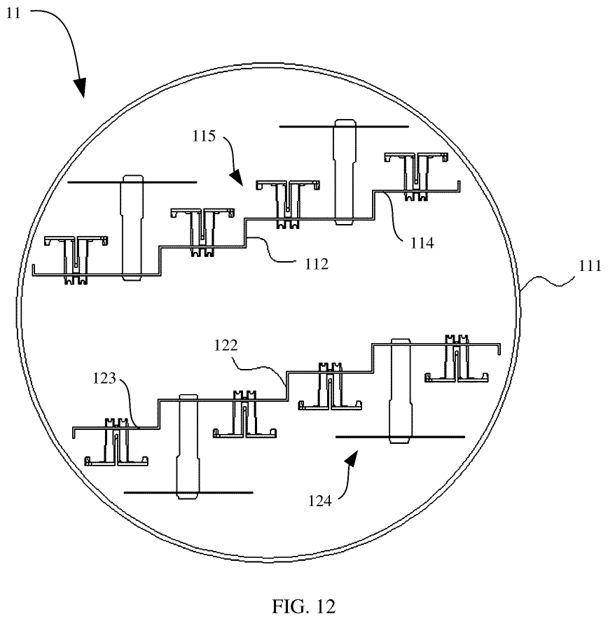

In this application, the antenna 11 may be a single-sided antenna or a double-sided antenna. For example, the antenna 11 shown in FIG. 4 is a single-sided antenna. FIG. 11 is a diagram of another structure of an antenna according to an embodiment of this application. As shown in FIG. 11, for example, in some technical solutions, the antenna 11 is a double-sided antenna. The antenna 11 includes the first stepped reflection panel 112 and a second stepped reflection panel 122 that are disposed in the radome 111. Specifically, the second stepped reflection panel 122 includes m second mounting plates 123, and m is an integer and m>1. Each second mounting plate 123 has a third surface (for example, a lower surface in FIG. 11) and a fourth surface (for example, an upper surface in FIG. 11) that faces away from the third surface. A second radiating element 124 is disposed on the third surface. A (j−1)^{th} second mounting plate 123 is disposed close to a fourth surface of a j^{th} second mounting plate 123, the (j−1)^{th} second mounting plate 123 is connected to the j^{th} second mounting plate 123 through a second connecting piece 125, and j=2, 3, 4, . . . , m. During specific disposition, the second stepped reflection panel 122 is disposed on a side that is of the first stepped reflection panel 112 and that faces away from the first radiating element 115. The first stepped reflection panel 112 is disposed on a side that is of the second stepped reflection panel 122 and that faces away from the second radiating element 124. Therefore, the first radiating element 115 and the second radiating element 124 are disposed opposite to each other, so that the antenna 11 can have two radiation directions.

Similar to disposition of the first radiating element 115, the m second mounting plates 123 may be disposed in parallel. This facilitates setting of a spacing between second radiating elements 124 on two adjacent second mounting plates 123, thereby simplifying a structure of the antenna 11. Alternatively, at least one of the m second mounting plates 123 may be disposed at an included angle with an adjacent second mounting plate 123. For example, a p^{th} second mounting plate 123 is disposed at an included angle with a (p−1)^{th} second mounting plate 123, and p=2, 3, 4, . . . , m. In this way, the second stepped reflection panel 122 can be adapted to a radome 111 having an irregular shape inside, and a directivity pattern of the antenna 11 can be symmetrical, thereby improving directivity pattern performance of the antenna 11.

Similar to disposition of the first connecting piece 116, the second connecting piece 125 may be a connecting plate. The connecting plate is connected between two adjacent second mounting plates 123, and the connecting plate is disposed at an included angle with the second mounting plate 123. The included angle may be, for example, 5°, 10°, 35°, 61°, 80°, 89°, or 90°. A specific value of the included angle may be set based on a first spacing and a second spacing between second radiating elements 124 on the two adjacent second mounting plates 123. This is not specifically limited herein. In this embodiment of this application, a connection manner of the connecting plate and the second mounting plate 123 is not limited, for example, may be threaded connection, welding, riveting, bonding, or the like. This is not specifically limited herein. Certainly, the second mounting plate 123 and the connecting plate may alternatively form an integrated structure by using an integral formation process, thereby improving structural strength of the second stepped reflection panel 122. In some other embodiments, the m second mounting plates 123 of the second stepped reflection panel 122 may alternatively be indirectly connected. For example, in a specific embodiment, the second connecting piece 125 may be a bolt, and the second mounting plate 123 of the second stepped reflection panel 122 may be fastened to the inner wall of the radome 111 through the bolt, so that the m second mounting plates 123 are indirectly connected through the radome 111, thereby simplifying a structure of the antenna 11. Certainly, in some other embodiments, the second connecting piece 125 may alternatively be a comb-shaped bracket. The comb-shaped bracket has a plurality of connecting parts disposed corresponding to the m second mounting plates 123. In this way, the m second mounting plates 123 are respectively connected to the corresponding connecting parts, to form the second stepped reflection panel 122.

Similar to disposition of the first radiating element 115, the second radiating element 124 may include a third-type radiating element and a fourth-type radiating element, and a radiation frequency of the third-type radiating element is different from a radiation frequency of the fourth-type radiating element. Therefore, the second radiating element 124 on the second stepped reflection panel 122 may also have one or two radiation frequencies, thereby implementing a single-frequency, dual-frequency, or multi-frequency working state.

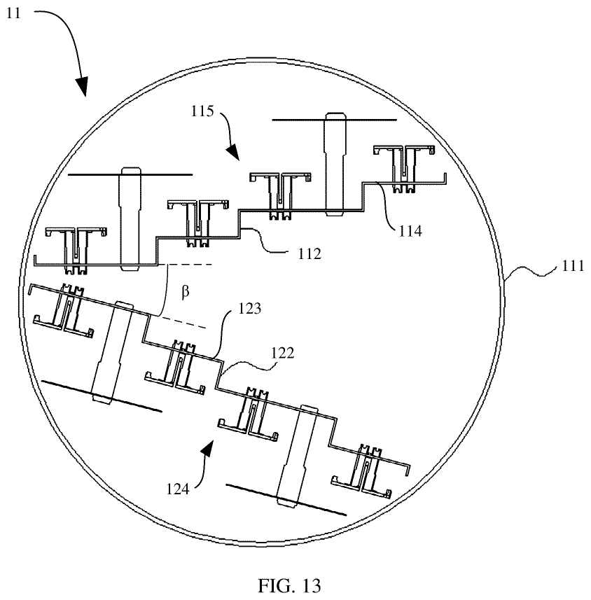

When the first stepped reflection panel 112 and the second stepped reflection panel 122 are specifically disposed, two radiation directions of the antenna 11 may be set based on a specific radiation direction requirement. FIG. 12 is a diagram of another structure of an antenna according to an embodiment of this application. For example, as shown in FIG. 11 and FIG. 12, in some embodiments, the n first mounting plates 114 of the first stepped reflection panel 112 may be disposed in parallel, the m second mounting plates 123 of the second stepped reflection panel 122 may also be disposed in parallel, and the first mounting plate 114 and the second mounting plate 123 are disposed in parallel. In this way, the antenna 11 has two opposite radiation directions. FIG. 13 is a diagram of another structure of an antenna according to an embodiment of this application. As shown in FIG. 13, in some other technical solutions, the n first mounting plates 114 of the first stepped reflection panel 112 are disposed in parallel, the m second mounting plates 123 of the second stepped reflection panel 122 are disposed in parallel, the first mounting plate 114 is disposed at an included angle with the second mounting plate 123, and the included angle β is greater than 0° and less than 180°. In other words, two radiation directions may be randomly selected as radiation directions of the double-sided antenna based on different application scenarios.

In addition, the m second mounting plates 123 may be evenly spaced in a direction perpendicular to the second mounting plate 123. For example, in some technical solutions, the antenna 11 may be a single-frequency antenna. In this case, that the m second mounting plates 123 are evenly spaced facilitates batch production of the antenna 11. Certainly, based on different radiation frequency requirements or size requirements of the antenna 11, these second mounting plates 123 may alternatively not be evenly spaced.

In the foregoing technical solution, the antenna 11 may further include a rotation drive apparatus. The rotation drive apparatus is connected to the stepped reflection panel 112, and the rotation drive apparatus is configured to drive the first stepped reflection panel 112 and/or the second stepped reflection panel 122 to rotate. To be specific, the rotation drive apparatus may drive the first stepped reflection panel 112 to rotate relative to the second stepped reflection panel 122, the rotation drive apparatus may drive the second stepped reflection panel 122 to rotate relative to the first stepped reflection panel 112, or the rotation drive apparatus may drive the first stepped reflection panel 112 and the second stepped reflection panel 122 to rotate. After the antenna 11 is mounted on the mounting bracket of the base station 10, the rotation drive apparatus may be remotely controlled to drive the first stepped reflection panel 112 and/or the second stepped reflection panel 122 to rotate at any angle, to change a radiation direction.

Terms used in the foregoing embodiments are merely for a purpose of describing specific embodiments, but are not intended to limit this application. The terms “one”, “a”, “the”, and “this” of singular forms used in this specification and the appended claims of this application are also intended to include expressions such as “one or more”, unless otherwise specified in the context clearly.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a radome; and
a first stepped reflection panel disposed in the radome, wherein the first stepped reflection panel comprises n first mounting plates, and wherein n is an integer and n>1;
wherein each first mounting plate of the n first mounting plates has a first surface and a second surface that faces away from the first surface, and further has a first radiating element disposed on the first surface; and
wherein an (i−1)^{th} first mounting plate of the n first mounting plates is disposed adjacent to a second surface of an i^{th} first mounting plate of the n first mounting plates, wherein the (i−1)^{th} first mounting plate is connected to the i^{th} first mounting plate by a first connecting piece, and wherein i is an integer and 1<i≤n.

2. The antenna according to claim 1, wherein the antenna further comprises a second stepped reflection panel disposed in the radome, wherein the second stepped reflection panel comprises m second mounting plates, and wherein m is an integer and m>1;
wherein each second mounting plate of the m second mounting plates has a third surface and a fourth surface that faces away from the third surface, and wherein a second radiating element is disposed on the third surface; and
wherein a (j−1)^{th} second mounting plate of the m second mounting plates is disposed adjacent to a fourth surface of a j^{th} second mounting plate of the m second mounting plates, wherein the (j−1)^{th} second mounting plate is connected to the j^{th} second mounting plate by a second connecting piece, and wherein j is an integer and 1<j≤m; and
wherein the second stepped reflection panel is disposed at a side that is of the first stepped reflection panel and that faces away from the first radiating element, and wherein the first stepped reflection panel is disposed at a side that is of the second stepped reflection panel and that faces away from the second radiating element.

3. The antenna according to claim 2, wherein the m second mounting plates are parallel to each other; or
wherein, in the m second mounting plates, a p^{th} second mounting plate is disposed at an included angle with a (p−1)^{th} second mounting plate, and p is an integer and 1<p≤m.

4. The antenna according to claim 2, wherein the antenna further comprises a rotation drive apparatus, wherein the rotation drive apparatus is connected to at least one of the first stepped reflection panel or the second stepped reflection panel, and wherein the rotation drive apparatus is configured to drive the at least one of the first stepped reflection panel or the second stepped reflection panel to rotate.

5. The antenna according to claim 1, wherein the n first mounting plates are parallel to each other; or
wherein, in the n first mounting plates, a q^{th} first mounting plate is disposed at an included angle with a (q−1)^{th} first mounting plate, and wherein q is an integer and 1<q≤n.

6. The antenna according to claim 1, wherein the radome is a cylindrical radome.

7. The antenna according to claim 1, wherein the first radiating element comprises a first-type radiating element and a second-type radiating element, and wherein a radiation frequency of the first-type radiating element is different from a radiation frequency of the second-type radiating element.

8. The antenna according to claim 7, wherein the first-type radiating element is disposed on a first surface of the (i−1)^{th} first mounting plate, and wherein the second-type radiating element is disposed on a first surface of the i^{th} first mounting plate.

9. The antenna according to claim 1, wherein the first connecting piece is a connecting plate, and wherein the connecting plate is disposed at an included angle with the first mounting plate.

10. The antenna according to claim 9, wherein the first mounting plate and the connecting plate are of an integrally formed structure.

11. The antenna according to claim 1, wherein the n first mounting plates are evenly spaced along a direction perpendicular to the first mounting plate.

12. A communication device, comprising:
a mounting bracket; and
an antenna, wherein the antenna is disposed on the mounting bracket;
wherein the antenna comprises:
a radome; and
a first stepped reflection panel disposed in the radome, wherein the first stepped reflection panel comprises n first mounting plates, and wherein n is an integer and n>1;
wherein each first mounting plate of the n first mounting plates has a first surface and a second surface that faces away from the first surface, and wherein a first radiating element is disposed on the first surface; and
wherein an (i−1)^{th} first mounting plate of the n first mounting plates is disposed adjacent to a second surface of an i^{th} first mounting plate of the n first mounting plates, wherein the (i−1)^{th} first mounting plate is connected to the i^{th} first mounting plate by a first connecting piece, and wherein i is an integer and 1<i≤n.

13. The communication device according to claim 12, wherein the antenna further comprises a second stepped reflection panel disposed in the radome, wherein the second stepped reflection panel comprises m second mounting plates, and wherein m is an integer and m>1;
wherein each second mounting plate of the m second mounting plates has a third surface and a fourth surface that faces away from the third surface, and wherein a second radiating element is disposed on the third surface; and
wherein a (j−1)^{th} second mounting plate of the m second mounting plates is disposed adjacent to a fourth surface of a j^{th} second mounting plate of the m second mounting plates, wherein the (j−1)^{th} second mounting plate is connected to the j^{th} second mounting plate through a second connecting piece, and wherein j is an integer and 1<j≤m; and
wherein the second stepped reflection panel is disposed on a side that is of the first stepped reflection panel and that faces away from the first radiating element, and wherein the first stepped reflection panel is disposed on a side that is of the second stepped reflection panel and that faces away from the second radiating element.

14. The communication device according to claim 12, wherein the m second mounting plates are parallel to each other; or
wherein, in the m second mounting plates, a p^{th} second mounting plate is disposed at an included angle with a (p−1)^{th} second mounting plate, and wherein p is an integer and 1<p≤m.

15. The communication device according to claim 12, wherein the n first mounting plates are parallel to each other; or in the n first mounting plates, a q^{th} first mounting plate is disposed at an included angle with a (q−1)^{th} first mounting plate, and q is an integer and 1<q≤n.

16. The communication device according to claim 12, wherein the radome is a cylindrical radome.

17. The communication device according to claim 12, wherein the first radiating element comprises a first-type radiating element and a second-type radiating element, and wherein a radiation frequency of the first-type radiating element is different from a radiation frequency of the second-type radiating element.

18. The antenna according to claim 17, wherein the first-type radiating element is disposed on a first surface of the (i−1)^{th} first mounting plate, and wherein the second-type radiating element is disposed on a first surface of the i^{th} first mounting plate.

19. The communication device according to claim 12, wherein the first connecting piece is a connecting plate, and wherein the connecting plate is disposed at an included angle with the first mounting plate.

20. The antenna according to claim 19, wherein the first mounting plate and the connecting plate are of an integrally formed structure.
